(19) United States
(12) Patent Application Publication
(10) Pub. No.: US 2024/0396596 A1
(43) Pub. Date: Nov. 28, 2024

(54) INTEGER AND NON-INTEGER BASED VECTOR PERTURBATION PRECODING IN MU-MIMO

(71) Applicant: Samsung Electronics Co., Ltd., Suwon-si (KR)

(72) Inventors: Pranav Madadi, Sunnyvale, CA (US); Joonyoung Cho, Portland, OR (US); Jianzhong Zhang, Dallas, TX (US)

(21) Appl. No.: 18/617,385

(22) Filed: Mar. 26, 2024

Related U.S. Application Data
(60) Provisional application No. 63/468,749, filed on May 24, 2023.
(60) Provisional application No. 63/525,532, filed on Jul. 7, 2023.

(51) Int. Cl. H04B 7/0452; H04W 72/23

(52) U.S. Cl. CPC H04B 7/0452; H04W 72/23

(57) ABSTRACT

Vector perturbation precoding of data is enabled or disabled by a base station, which transmits to a user equipment information including vector perturbation schemes and parameters related to vector perturbation precoding. Perturbation vectors are determined based on the vector perturbation schemes, perturbation vectors, and data signals are modulated with the perturbation vectors, with the modulated data signals being transmitted to the user equipment. The vector perturbation precoding parameters may include a power normalization factor, a modulo threshold, and quantization parameters. A downlink control information may indicate a switch between the vector perturbation schemes and a linear precoding scheme.

### CROSS-REFERENCE TO RELATED APPLICATION AND PRIORITY CLAIM

This application claims priority under 35 U.S.C. § 119 (e) to U.S. Provisional Patent Application No. 63/468,749 filed on May 24, 2023, and U.S. Provisional Patent Application No. 63/525,532 filed on Jul. 7, 2023, which are hereby incorporated by reference in their entirety.

### TECHNICAL FIELD

This disclosure relates generally to vector perturbation precoding for wireless communication. More specifically, this disclosure relates to improving both integer and non-integer type vector perturbation.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources that is included in a portable electronic device. Thus, improved methods and apparatus for configuring and deploying media processing in the network are needed.

### SUMMARY

This disclosure provides a method and apparatus for improving both integer and non-integer type vector perturbation. Vector perturbation precoding of data is enabled or disabled by a base station, which transmits to a user equipment information including vector perturbation schemes and parameters related to vector perturbation precoding. Perturbation vectors are determined based on the vector perturbation schemes, and data signals are modulated with the perturbation vectors, with the modulated data signals being transmitted to the user equipment. The vector perturbation precoding parameters may include a power normalization factor, a modulo threshold, and quantization parameters. A downlink control information may indicate a switch between the vector perturbation schemes and a linear precoding scheme.

In a first embodiment, a method performed by a base station (BS) in a communication system includes enabling or disabling vector perturbation precoding of data. The method further includes transmitting, to a user equipment (UE), information including vector perturbation schemes and parameters related to vector perturbation precoding. The method still further includes determining, based on the vector perturbation schemes, perturbation vectors. The method also includes modulating data signals with the perturbation vectors. The method includes transmitting, to the UE, the modulated data signals.

In a second embodiment, a base station (BS) in a communication system includes a transceiver and a processor. The processor is configured to enable or disable vector perturbation precoding of data. The processor is further configured to transmit, to a user equipment (UE), information including vector perturbation schemes and parameters related to vector perturbation precoding. The processor is still further configured to determine, based on the vector perturbation schemes, perturbation vectors. The processor is also configured to modulate data signals with the perturbation vectors. The processor is configured to transmit, to the UE, the modulated data signals.

In a third embodiment, a user equipment (UE) in a communication system includes a transceiver and a processor. The transceiver is configured to receive, from a base station (BS), signaling enabling or disabling vector perturbation precoding of data. The transceiver is further configured to receive, from the BS, information including vector perturbation schemes and parameters related to vector perturbation precoding. The transceiver is still further configured to receive, from the BS, data signals modulated by perturbation vectors determined based on the vector perturbation schemes. The processor configured to demodulate the data signals according to the perturbation vectors.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network 100 within which AI-supported vector perturbation precoding may be implemented according to embodiments of the present disclosure;

FIG. 2 illustrates an example gNB 102 within which AI-supported vector perturbation precoding may be implemented according to embodiments of the present disclosure;

FIG. 3 illustrates an example UE 116 within which AI-supported vector perturbation precoding may be implemented according to embodiments of the present disclosure;

FIG. 4A and FIG. 4B illustrate an example of wireless transmit and receive paths, respectively, that may transmit or receive signals with AI-supported vector perturbation precoding according to embodiments of the present disclosure;

FIG. 5 illustrates one possible framework for vector perturbation precoding with neural network support in accordance with embodiments of the present disclosure;

FIG. 6 is a high level flowchart for an example of BS operation to support vector perturbation precoding in accordance with embodiments of the present disclosure;

FIG. 7 is a high level flowchart of a process of BS operations for an embodiment enabling dynamic switching between precoding schemes in accordance with embodiments of the present disclosure;

FIG. 8 is a high level flowchart of a process of UE operations for an embodiment enabling dynamic switching between precoding schemes in accordance with embodiments of the present disclosure;

FIG. 9 illustrates one possible framework for decoding received signals with neural network support for determining vector perturbation of the transmitted signal in accordance with embodiments of the present disclosure; and

FIG. 10 is a high level flowchart of a process of UE operation to support vector perturbation precoding in accordance with embodiments of the present disclosure.

### DETAILED DESCRIPTION

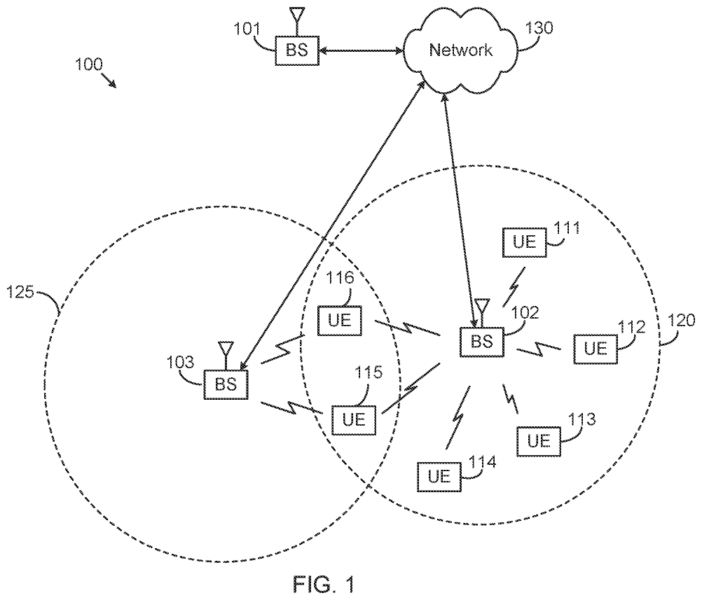

FIGS. 1 through 10, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

### Abbreviations

ML Machine Learning
AI Artificial Intelligence
gNB Base Station
UE User Equipment
NR New Radio
FDD Frequency Division Duplex
TDD Time Division Duplex
CSI Channel State Information
CQI Channel Quality Indicator
PMI Precoding Matrix Indicator
3GPP 3rd Generation Partnership Project
RRC Radio Resource Control
DCI Downlink Control Information
UCI Uplink Control Information
PDCCH Physical Downlink Control Channel
PDSCH Physical Downlink Shared Channel
PUCCH Physical Uplink Control Channel
PUSCH Physical Uplink Shared Channel
MAC CE Medium Access Control Control Element
DL Downlink
UL Uplink
LTE Long-Term Evolution

Massive multiple-input multiple-output (MIMO) is widely regarded as one of the key techniques in the fifth-generation wireless communication system. With a larger antenna array, such system is able to boost both spectrum and energy efficiency, and further support higher order multi-user (MU)-MIMO transmission in order to maximize the system performance.

One component of a MIMO transmission scheme is the precoding scheme. Dirty paper coding (DPC, a/k/a Costa precoding) has proven optimal to access the sum capacity of the MIMO broadcast channel (BC), but there are many challenges to put DPC into practice and, to circumvent the problem(s), many suboptimal precoding techniques have been proposed. These techniques mainly lie into two categories: linear precoding and non-linear precoding. Zero-forcing (ZF) precoding (or channel inversion) and minimum mean square error (MMSE) are among the most commonly-referenced linear precoding schemes, providing lower complexity but suffering from performance loss compared with non-linear precoding schemes. Vector perturbation (VP) precoding and Tomlinson-Harashima (TH) precoding are two representative non-linear precoding techniques. VP precoding has been proven to achieve full diversity.

In conventional VP precoding (CVP), the transmitter adds a perturbation vector to the modulated data vector and generates the transmit vector by multiplying the perturbed vector with a precoding matrix. The transmitter selects the precoding matrix to mitigate inter-user interference and solves for the perturbation vector under the criterion of reducing unscaled transmit power with a so-called sphere decoder. The receiver recovers the data vector(s) individually by multiplying a power scaling factor and then passing the scaled vector through a modulo operator to eliminate the effect of perturbed vector.

The algorithm to find an optimal perturbation vector is very complex, thus the present disclosure leverages neural network-based models to implement various schemes of vector perturbation precoding to achieve better performance.

MIMO transmission has gained considerable attention recently due to the potential to increase the system throughput dramatically. For MU-MIMO, linear precoding is a conventional approach to separate users spatially. However, by consuming degrees of freedoms in MIMO systems to create perfect nulls for non-target UEs, a tradeoff between interference mitigation and achievable spatial diversity arises. Moreover, the inter-user interference mitigation performance of linear precoding degrades considerably in ill-conditioned or spatially-correlated channels, limiting achievable throughput. Such channels can be found in crowded environment, where channels seen by UEs may overlap spatially. In these cases, non-linear precoding techniques like vector perturbation has shown to be very promising. Such non-linear precoding techniques successfully mitigate the inter-user interference such UEs can independently decode data.

FIGS. 1-3 and 4A-4B describe various embodiments implemented in wireless communications systems and with the use of orthogonal frequency division multiplexing (OFDM) or orthogonal frequency division multiple access (OFDMA) communication techniques. The descriptions of FIGS. 1-3 and 4A-4B are not meant to imply physical or architectural limitations to how different embodiments may be implemented. Different embodiments of the present disclosure may be implemented in any suitably arranged communications system.

FIG. 1 illustrates an example wireless network 100 within which AI-supported vector perturbation precoding may be implemented according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 3^{rd} Generation Partnership Project 5G/New Radio (NR), long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 3GPP 5G/NR, Long Term Evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for improving both integer and non-integer type vector perturbation. In certain embodiments, one or more of the BSs 101-103 include circuitry, programing, or a combination thereof for improving both integer and non-integer type vector perturbation.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

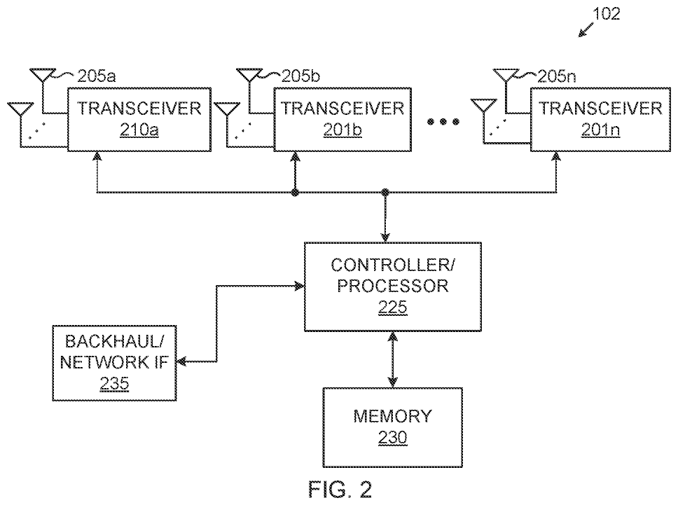

FIG. 2 illustrates an example gNB 102 within which AI-supported vector perturbation precoding may be implemented according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for improving both integer and non-integer type vector perturbation. Any of a wide variety of other functions could be supported in the gNB 102 by the controller/processor 225.

The controller/processor 225 is also capable of executing programs and other processes resident in the memory 230, such as processes for improving both integer and non-integer type vector perturbation. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

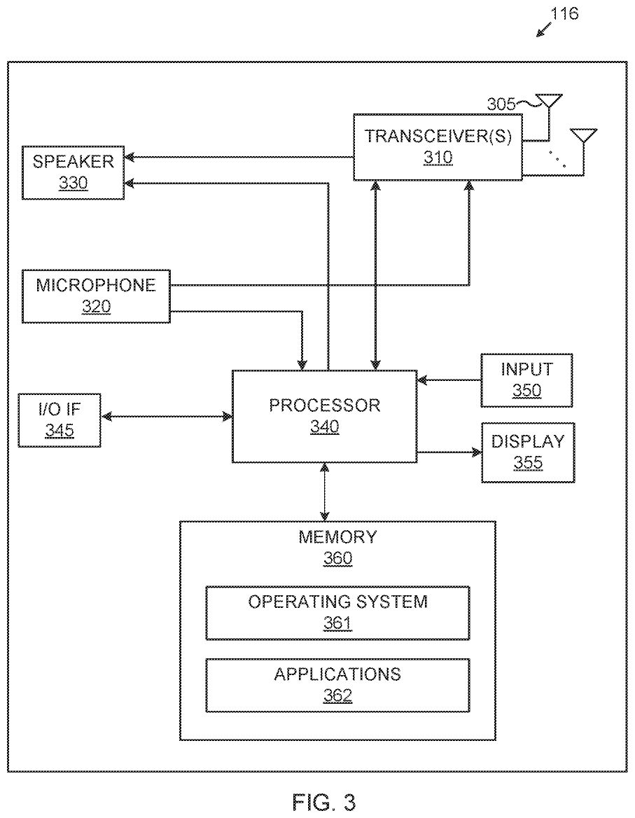

FIG. 3 illustrates an example UE 116 within which AI-supported vector perturbation precoding may be implemented according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for improving both integer and non-integer type vector perturbation as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

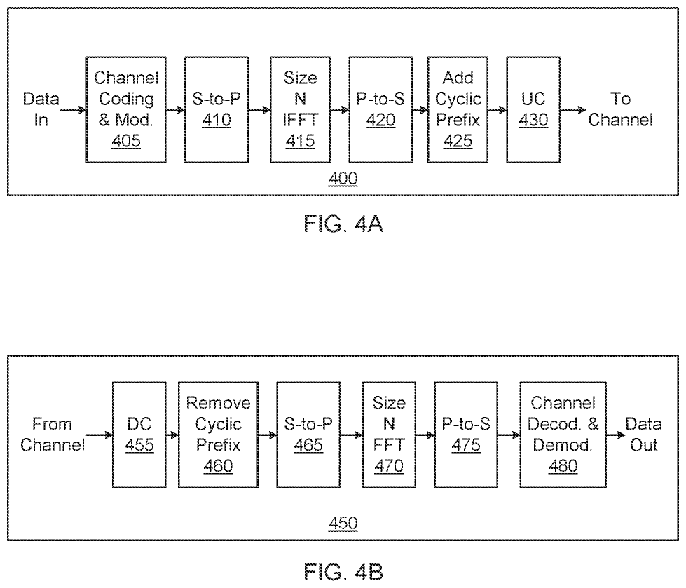

FIG. 4A and FIG. 4B illustrate an example of wireless transmit and receive paths 400 and 450, respectively, that may transmit or receive signals with AI-supported vector perturbation precoding according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to transmit data signals with improved perturbation vectors as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In general, current implementation(s) of MIMO precoding support linear precoding schemes but do not support non-linear precoding schemes, specifically vector perturbation precoding. Implementation of a vector perturbation scheme requires changes in the processing of data, i.e., PDSCH decoding, signaling between BS and UE, and setting various required parameters. In this disclosure, the problem of providing support for various schemes of vector perturbation precoding are handled based on both AI and non-AI models.

Support for both AI and non-AI based vector perturbation precoding could require incorporation of detailed signaling between the BS and the UE using higher layer messages such as radio resource control (RRC) messages or DCI in PDCCH messages. Data processing at the transmitter (e.g., BS) needs to include determination and addition of the perturbation vector to the modulated symbols, by determining an optimal scheme and parameters required to determine that perturbation vector. Various tables in the 3GPP current standards needs to be updates for effective communication of required parameters for successful decoding at UEs.

### Vector Perturbation Algorithm

Assume that the base station deploys N_{τ} transmit antennas and serves Nᵣ single antenna users simultaneously, from which it follows that Nᵣ≤ Nₜ. The channel vector of user i is denoted as hᵢ=[hᵢ₁, . . . , h_{iN}_{ₜ}]^{T}, where hᵢⱼ signifies the channel gain between the jth transmit antenna and ith user.

The receive signal at user i is given by

$${y}_{i} = {h}_{i}^{T} x + {n}_{i} ,$$

where x is the transmit vector, nᵢ is the zero-mean complex Gaussian noise at user i, which has a variance of σₙ².

By stacking the received signal of Nᵣ users, we can obtain the received vector as

$$y = H x + n ,$$

where H is the channel matrix and n is the additive noise vector.

The base station generates the symbol data vector u=[u₁, . . . , u_{N}_{ₜ}]^{T} from a bit vector by mapping bits to modulation symbols.

VP precoding pursues to reduce the transmit power by perturbing the data vector u with a scaled integer vector v, the perturbation vector.

The perturbation vector v is selected to minimize the unscaled power of perturbed data vector v′:

$${v}^{′} = arg {min}_{v} ‖ W ( u + τ v ) ‖ ,$$

where W is the precoder matrix and τ is the scaling parameter.

In general, perturbation by an arbitrary complex vector is not possible because this perturbation is not known to the receivers and would, therefore, cause decoding errors. Thus, using the idea derived from TH precoding, where each element of u to be perturbed is perturbed by an integer, integer-valued perturbation vectors are predominantly used.

However, with the advent of artificial intelligence (AI) applications in wireless communications, a real-valued vector perturbation can be used with help of neural network based decoder. Thus, there are two vector perturbation schemes:

### 1. Integer-Based Vector Perturbation

Assume an integer-valued perturbation vector. The optimization mentioned above is the an Nᵣ dimensional integer-lattice least-squares problem, for which there is a large selection of exact and approximate algorithms, for example, algorithms by Fincke and Pohst or Kannan. The Fincke-Pohst algorithm can be used for space-time demodulation in what is called a sphere decoder. The algorithm avoids an exhaustive search over all possible integers in the lattice by limiting the search space to a sphere of some given radius centered around a starting point. In an embodiment of the disclosure, the center can be the vector u. We assume that a complex version is used or that the optimization has been converted to a 2Nᵣ-dimensional real lattice problem. Even for integer-valued vector perturbation, AI methods with quantization can be used for finding the optimal perturbation vector.

The scalar τ is a design parameter that may be chosen to provide a symmetric decoding region around (the real or imaginary part of) every signal constellation point. The value of τ is usually tied to the modulation order as follows:

$$τ = 2 ( {\vert c \vert}_{max} + \frac{Δ}{2} ) ,$$

ere |c|ₘₐₓ the absolute value of the constellation symbol(s) with largest magnitude, and Δ is the spacing between constellation points.

Then the transmit vector x can be formed by multiplying the perturbed data vector with a precoder matrix W (u+τv′), and normalized to unit power at base station to follow the transmit power limit as

$$x = \frac{1}{γ} W ( u + τ {v}^{′} ) , \qquad ( 1 )$$

$$where γ = \sqrt{{‖ W ( u + τ {v}^{′} ) ‖}^{2}}$$

is the power scaling factor. It is obvious that γ is determined not only by precoding matrix W but also by data vector u.

It is assumed that all receivers could have known γ perfectly in advance of transmission in equation (1). The received signal vector recovered with γ is denoted as

$$r = γ y = H W ( u + τ {v}^{′} ) + γ n .$$

User i estimates the data symbol f_{τ}(y) by performing a modulo operation given by

$${f}_{τ} ( y ) = y - ⌊ \frac{y + \frac{τ}{2}}{τ} ⌋ τ ,$$

where └·┘ denotes the modulo operation.

Thus, for effective decoding of data at each UE, signaling support should be provided for communicating the power normalization factor. Further, the processing of a PDSCH should be updated to include evaluating the modulo threshold parameter τ and to implement power scaling followed by the modulo operation.

### 2. Non-Integer Type Vector Perturbation

As discussed above, the perturbation vector in conventional VP precoding is commonly integer-valued for one or more of two reasons: less complexity, based on implementing sphere decoding on an integer-lattice; and a modulo operation can be applied at the receiver without the need to know the exact perturbation vector. In the present disclosure, AI/ML can be used as either an optimization tool, to obtain optimal real-valued (non-integer) perturbation vectors, and/or in the decoder design, to effectively decode data vector without the need for information about perturbation vectors.

Relaxing the integer-valued constraint on perturbation vectors can improve coded block error rate (cBER) performance. For example, perturbation vectors with not integer values may be used, such as:

$${V}^{+} = \{ 0 , - 1 , - 1.25 , … , - 1 - 1.25 \times {a}_{max} \} , {u}_{r} , {u}_{i} = 1 , or$$

$${V}^{-} = \{ 0 , 1 , 1.25 , … , 1 + 1.25 \times {a}_{max} \} , {u}_{r} , {u}_{i} = - 1 ,$$

or
Use of AI/ML as an optimization tool makes it is possible to select a perturbation vector that gives smaller power normalization factor γ. However, the decoder needs some information about the perturbation vector, either the exact value or a probability distribution, in order to determine log-likelihood ratios (LLRs).

For a given search radius around the data vector u, given by the modulo threshold parameter t, AI methods can be applied to find the generic non-integer perturbation vector the minimizes the power as given in equation (1). A real valued perturbation vector has to be quantized before transmission, thus a quantization parameter η is determined as the quantization of the perturbation vector. The transmit vector is normalized in the same manner as before and the power normalization factor γ needs to be communicated to UEs.

For data decoding at UE, one can no longer apply the modulo operation. With no information available about the perturbation vector, a pre-trained AI based decoder is implemented that is dependent on the power normalization factor γ, the modulo threshold parameter τ, and the quantization parameter η.

Embodiments of the disclosure are applicable in general to any communication system implementing precoding for MU-MIMO scenario.

In an embodiment, the BS sends data to multiple UEs implementing vector perturbation precoding such that all UEs can individually decode the respective data for the UE with minimal interference.

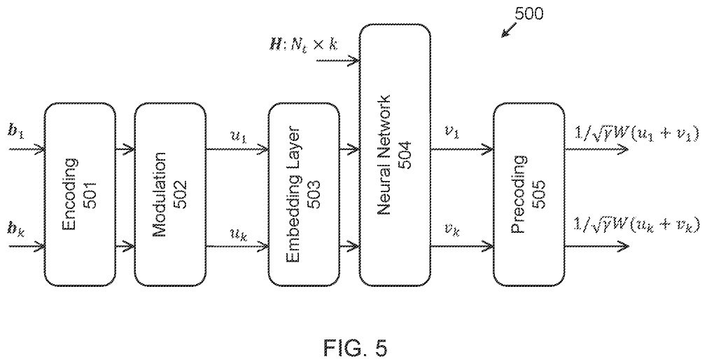

FIG. 5 illustrates one possible framework for vector perturbation precoding with neural network support in accordance with embodiments of the present disclosure. The framework 500 illustrated in FIG. 5 is for illustration only, and FIG. 5 does not limit the scope of this disclosure to any particular implementation. The framework 500 may be employed within BS 102 in FIGS. 1 and 2.

The framework 500 assumes the BS has N_{τ} transmit antennas and serves k UEs under a Rayleigh channel H. In framework 500, b₁, . . . , bₖ is the coded bit vector for user i, where the constellation symbol corresponding to the coded bits may be for 16 QAM, 16 non-uniformity correction (NUC), or the like. The coded bit vector b₁, . . . , bₖ is operated on by encoding 501 and modulation 502 to produce symbol data vector u₁, . . . , uₖ. The symbol data vector u₁, . . . , uₖ are received by embedding layer 503, the output of which is received, together with an estimate of the channel H, by a neural network 504. The neural network 504 produces an inference regarding the optimal perturbation vector v₁, . . . , vₖ based on the channel and the constellation size. The perturbation vector v₁, . . . , vₖ is determined based on minimizing a loss function BCE+γ|W(u+v)|², where BCE is binary cross-entropy loss. The elements vᵢ of the perturbation vector v₁, . . . , vₖ are real valued perturbations limited within a range defined by τ. The perturbation vector v₁, . . . , vₖ and the symbol data vector u₁, . . . , uₖ are used by precoding 505, which may perform ZF precoding and power normalization to generate the signals

$$\frac{1}{\sqrt{γ}} W ( {u}_{1} + {v}_{1} ) , … , \frac{1}{\sqrt{γ}} W ( {u}_{k} + {v}_{k} )$$

transmitted on the channel H.

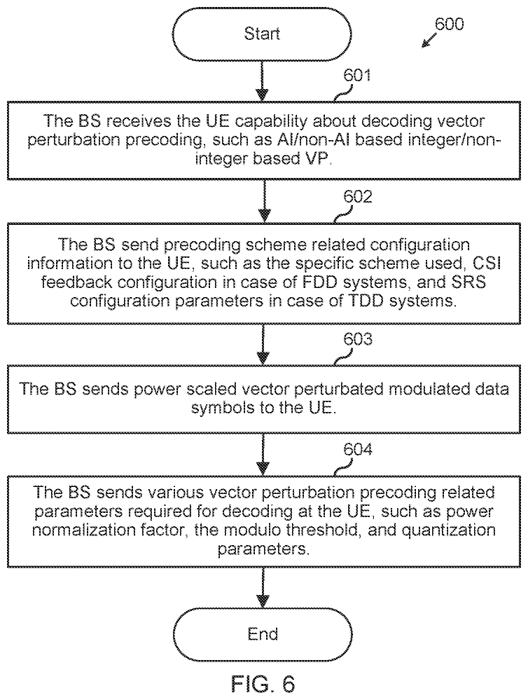

FIG. 6 is a high level flowchart for an example of BS operation to support vector perturbation precoding in accordance with embodiments of the present disclosure. The process 600 illustrated in FIG. 6 is for illustration only, and FIG. 6 does not limit the scope of this disclosure to any particular implementation. The process 500 may be performed by the controller/processor 225 in FIG. 2.

FIG. 6 is an example of a method 600 for operations at BS side to support vector perturbation precoding. At operation 601, the BS receives a UE capability to decode vector perturbation precoding. The UE capability information related to vector perturbation precoding techniques can include one or multiple information such as
capability to implement modulo operation for decoding integer-based scheme; or
capability to decode AI-based models for decoding non-integer based schemes.
   The report of the capability information can be received via physical uplink control channel (PUCCH) as an uplink control information (UCI). In another embodiment, a MAC CE identified by a MAC protocol data unit (PDU) subheader to be carried in a physical uplink shared channel (PUSCH) can be used to indicate UE Data decoding capability.

At operation 602, the BS enables/disables vector perturbation based on the channel conditions. The BS may determine whether to use VP or not and communicate a result of that determination to the UE. For example, the BS may enable vector perturbation precoding if the channel is ill-conditioned, such as severe fading high correlation, high singular value of inverse channel, and may enable linear precoding otherwise. In another embodiment, the BS can group UEs with close proximity to UE-group specific vector perturbation precoding, and employ linear precoding for other users. In one example, the BS can employ integer/non-integer based vector perturbation or linear precoding based on the channel conditions to the UE, where highly correlated channel or highly proximal UEs are scheduled with vector perturbation and UEs with well-conditioned channel with line-of-sight are scheduled with linear precoding. In another example, the UE sends assistance information to BS such as a resource situation that may include, but which is not limited to, battery power, low computational power, etc. The BS can employ linear precoding or vector perturbation based on the UE assistance information, where linear precoding can be scheduled to UEs with low computational power.

In another embodiment, the UE may suggest that the BS use integer or non-integer vector perturbation based on the understanding of the UE's local situation/environment. In one example, in FDD systems, the UE can have access to a highly accurate channel, which the UE may not communicate to BS due to resulting high-overhead, and can make suggestions to change precoding schemes based on this information.

When vector perturbation precoding is enabled, the BS may send the related configuration information to UE, which can include the specific vector perturbation scheme used such as integer/non-integer vector perturbation, CSI feedback reporting parameters to have highly accurate channel state information at the BS, SRS configuration information. A part of or all the configuration information can be sent via UE-specific signaling, or group-specific signaling.

In one embodiment, dynamic switching between different schemes such as linear precoding and integer and non-integer vector perturbation schemes can be enabled by a combination of higher layer signaling, such as a single bit VPprecoding field in the PDSCH-config RRC message as indicated by TABLES 1 and 2 (with the new parameter VPPrecoding in both) below, which can be used to enable/disable vector perturbation precoding. TABLE 1 illustrates pseudocode, while TABLE 2 illustrates a field in the RRC message PDSCH-config for an embodiment with dynamic switching:

TABLE 1
PDSCH-config ::= SEQUENCE {

| | |
|---|---|
| dataScramblingIdentityPDSCH | Integer (0..1023) OPTIONAL, -- NEED |

S

| | |
|---|---|
| dmrs-DownlinkForPDSCH-MappingTypeA | SetupRelease { DMRS-DownlinkConfig |

} OPTIONAL, -- NEED M

| | |
|---|---|
| dmrs-DownlinkForPDSCH-MappingTypeB | SetupRelease { DMRS-DownlinkConfig |

} OPTIONAL, -- NEED M

| tci-StatesToAddModList | SEQUENCE (SIZE(1..maxNrofTCI- | |
|---|---|---|
| States)) OF TCI-State | OPTIONAL, -- NEED N | |
| tci-StatesToReleaseList | SEQUENCE (SIZE(1..maxNrofTCI- | |
| States)) OF TCI-StateId | OPTIONAL, -- NEED N | |
| vrb-ToPRBInterleaver | ENUMERATED {N2, N4} | OPTIONAL, - |

- NEED S

| | |
|---|---|
| resourceAllocation | ENUMERATED { |

resourceAllocationType0, resourceAllocationType1, dynamicSwitch } ,

| | |
|---|---|
| pdsch-TimeDomainAllocationList | SetupRelease {PDSCH- |
| TimeDomainResourceAllocationList } | OPTIONAL, -- NEED M |
| pdsch-AggregationFactor | ENUMERATED { n2, n4, n8 } |

OPTIONAL, -- NEED S

| rateMatchPatternToAddModList | SEQUENCE | |
|---|---|---|
| (SIZE(1..maxNrofRateMatchPatterns)) OF | RateMatchPattern | OPTIONAL, - |

- NEED N

| | |
|---|---|
| rateMatchPatternToReleaseList | SEQUENCE |
| (SIZE(1..maxNrofRateMatchPatterns)) OF | RateMatchPatternId |

OPTIONAL, -- NEED N

| | | |
|---|---|---|
| rateMatchPatternGroup1 | RateMatchPatternGroup | OPTIONAL, - |

- NEED R

| | | |
|---|---|---|
| rateMatchPatternGroup2 | RateMatchPatternGroup | OPTIONAL, - |

- NEED R

| | |
|---|---|
| rgb-Size | ENUMERATED {config1, config2}, |
| mc-Table | ENUMERATED {qam256, qam64LowSE} |

OPTIONAL, -- NEED S

| | |
|---|---|
| VPPrecoding | BOOLEAN |
| Prb-BundlingType | CHOICE { ... |

TABLE 2
maxNrofCodeWordsScheduledByDCI
Maximum number of code words that a single DCI may schedule. This changes the
number of MCS/RV/NDI bits in the DCI message from 1 to 2.
VPPrecoding
Enables vector perturbation precoding, which enables the UE to perform data
decoding based on the scheme specified by VPScheme in DCI message.
mcs-Table
Indicates which MCS table the UE shall use for PDSCH for DCI formats 1_0 and
1_1 (see TS 38.314 [19], clause 5.1.3.1). If all fields are absent, the UE applies the
value 62QAM. If the field mcs-Table-r17 is present for DCI format 1_1, the
network does not configure the filed mcs-Table (without suffix). For a RedCap UE,
the 256QAM MCS table for PDSCH is only supported if the UE indicates support
of 256QAM for PDSCH.

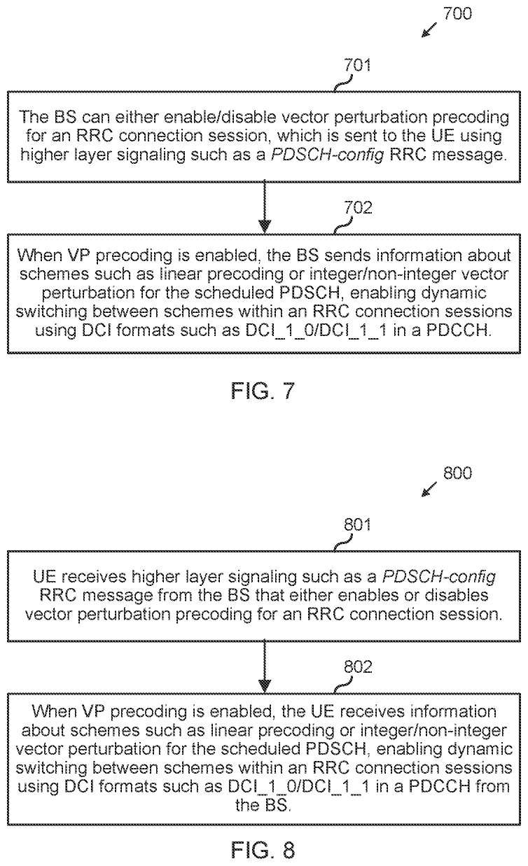

The combination of higher layer signaling enabling dynamic switching between different schemes can also include a field VPScheme in a PDCCH DCI message, which can be used to indicate the enabling/disabling of vector perturbation precoding and integer-based/non-integer based vector perturbation precoding scheme for the scheduled PDSCH. Exemplary BS and UE operations are illustrated in FIGS. 7 and 8.

In another embodiment, the VPPrecoding field in the PDSCH-config RRC message can be used to communicate the specific precoding algorithm for the RRC connection session such as linear precoding, integer, non-integer vector perturbation precoding as illustrated in TABLES 3 and 4 below. TABLE 3 illustrates pseudocode, while TABLE 4 illustrates a field in the RRC message PDSCH-config for an embodiment with dynamic switching:

TABLE 3
PDSCH-config ::= SEQUENCE {

| | |
|---|---|
| dataScramblingIdentityPDSCH | Integer (0..1023) OPTIONAL, -- NEED |

S

| | |
|---|---|
| dmrs-DownlinkForPDSCH-MappingTypeA | SetupRelease { DMRS-DownlinkConfig |

} OPTIONAL, -- NEED M

| | |
|---|---|
| dmrs-DownlinkForPDSCH-MappingTypeB | SetupRelease { DMRS-DownlinkConfig |

} OPTIONAL, -- NEED M

| tci-StatesToAddModList | SEQUENCE (SIZE(1..maxNrofTCI- | |
|---|---|---|
| States)) OF TCI-State | OPTIONAL, -- NEED N | |
| tci-StatesToReleaseList | SEQUENCE (SIZE(1..maxNrofTCI- | |
| States)) OF TCI-StateId | OPTIONAL, -- NEED N | |
| vrb-ToPRBInterleaver | ENUMERATED {N2, N4} | OPTIONAL, - |

- NEED S

| | |
|---|---|
| resourceAllocation | ENUMERATED { |

resourceAllocationType0, resourceAllocationType1, dynamicSwitch },

| | |
|---|---|
| pdsch-TimeSomainAllocationList | SetupRelease {PDSCH- |
| TimeDomainResourceAllocationList } | OPTIONAL, -- NEED M |
| pdsch-AggregationFactor | ENUMERATED { n2, n4, n8 } |

OPTIONAL, -- NEED S

| rateMatchPatternToAddModList | SEQUENCE | |
|---|---|---|
| (SIZE(1..maxNrofRateMatchPatterns)) OF | RateMatchPattern | OPTIONAL, - |

- NEED N

| | |
|---|---|
| rateMatchPatternToReleaseList | SEQUENCE |
| (SIZE(1..maxNrofRateMatchPatterns)) OF | RateMatchPatternId |

OPTIONAL, -- NEED N

| | | |
|---|---|---|
| rateMatchPatternGroup1 | RateMatchPatternGroup | OPTIONAL, - |

- NEED R

| | | |
|---|---|---|
| rateMatchPatternGroup2 | RateMatchPatternGroup | OPTIONAL, - |

- NEED R

| | |
|---|---|
| rgb-Size | ENUMERATED {config1, config2}, |
| mc-Table | ENUMERATED {qam256, qam64LowSE} |

OPTIONAL, -- NEED S

| | |
|---|---|
| VPPrecoding | INTEGER ( 0..2 ) |
| Prb-BundlingType | CHOICE ( ... |

TABLE 4
maxNrofCodeWordsScheduledByDCI
Maximum number of code words that a single DCI may schedule. This changes the
number of MCS/RV/NDI bits in the DCI message from 1 to 2.
VPPrecoding
Indicates the downlink precoding scheme. The UE is to perform data decoding
based on the scheme indicated.
mcs-Table
Indicates which MCS table the UE shall use for PDSCH for DCI formats 1_0 and
1_1 (see TS 38.314 [19], clause 5.1.3.1). If all fields are absent, the UE applies the
value 62QAM. If the field mcs-Table-r17 is present for DCI format 1_1, the
network does not configure the filed mcs-Table (without suffix). For a RedCap UE,
the 256QAM MCS table for PDSCH is only supported if the UE indicates support
of 256QAM for PDSCH.

FIG. 7 is a high level flowchart of a process of BS operations for an embodiment enabling dynamic switching between precoding schemes in accordance with embodiments of the present disclosure. The process 700 illustrated in FIG. 7 is for illustration only, and FIG. 7 does not limit the scope of this disclosure to any particular implementation. The process 700 may be performed by the controller/processor 225 in FIG. 2.

In process 700, the BS can either enable/disable vector perturbation precoding for an RRC connection session, which is sent to the UE using higher layer signaling such as a PDSCH-config RRC message (operation 701). When VP precoding is enabled, the BS sends information about schemes such as linear precoding or integer/non-integer vector perturbation for the scheduled PDSCH, enabling dynamic switching between schemes within an RRC connection sessions using DCI formats such as DCI_1_0/DCI_1_1 in a PDCCH (operation 702).

Although FIG. 7 illustrates one example process 700 for BS operation to support vector perturbation precoding, various changes may be made to FIG. 7. For example, while shown as a series of steps, various steps in FIG. 7 may overlap, occur in parallel, or occur any number of times.

FIG. 8 is a high level flowchart of a process of UE operations for an embodiment enabling dynamic switching between precoding schemes in accordance with embodiments of the present disclosure. The process 800 illustrated in FIG. 8 is for illustration only, and FIG. 8 does not limit the scope of this disclosure to any particular implementation. The process 800 may be performed by the processor 340 of FIG. 3.

In process 800, the UE receives higher layer signaling such as a PDSCH-config RRC message from the BS that either enables or disables vector perturbation precoding for an RRC connection session (operation 801). When VP precoding is enabled, the UE receives information about schemes such as linear precoding or integer/non-integer vector perturbation for the scheduled PDSCH, enabling dynamic switching between schemes within an RRC connection sessions using DCI formats such as DCI_1_0/DCI_1_1 in a PDCCH from the BS (operation 802).

Although FIG. 8 illustrates one example process 800 for UE operation to support vector perturbation precoding, various changes may be made to FIG. 8. For example, while shown as a series of steps, various steps in FIG. 8 may overlap, occur in parallel, or occur any number of times.

The BS can use the higher layer CSI reporting configuration sent to the UE using RRC messages to enable high-resolution CSI feedback such as Type-2 CSI feedback in case of codebook based CSI feedback in FDD systems since vector perturbation precoding algorithms require highly accurate channel state information. In one embodiment, if the UE is capable of AI-based CSI feedback the BS can enable such AI-based feedback to have highly accurate channel state information with low overhead. In TDD systems, the BS can also configure the SRS reporting periodicity, transmit power to enable highly accurate channel at the BS.

Referring back to FIG. 6, at operation 603, the BS perturbs the modulated data according to the configured vector perturbation scheme. In integer-based vector perturbation scheme, the optimal perturbed vector can be determined by the BS either by non-AI algorithms such as sphere decoding or AI methods. In both cases, the modulo threshold parameter can introduce the constraint in the search space. The final step of implementing vector perturbation is to do power scaling.

At operation 604, the BS sends vector perturbation scheme related parameters required for decoding at UE, such as the modulo threshold/quantization parameters specific to a modulation order/code rate as specified in pre-defined tables and a power normalization parameter.

Although FIG. 6 illustrates one example process 600 for BS operation to support vector perturbation precoding, various changes may be made to FIG. 6. For example, while shown as a series of steps, various steps in FIG. 6 may overlap, occur in parallel, or occur any number of times.

In one embodiment, the modulation order can be tied with the modulo threshold parameter τ as follows:

$$τ = 2 ( {\vert c \vert}_{max} + \frac{Δ}{2} ) , ere {\vert c \vert}_{max}$$

the absolute value of the constellation symbol(s) with largest magnitude, and Δ is the spacing between constellation points.

The value of τ can be increased, thereby increasing the decoding region at the upper and lower extremes of the constellation and potentially reducing the effects of the perturbation vector. While this improves error performance in these decoding regions, the resulting γ is typically also larger, reducing total error performance. If τ is made smaller than 2|c|ₘₐₓhen error-free decoding becomes impossible, even in the absence of channel noise.

Thus, in another embodiment, the value of τ can be considered as a hyper parameter in the AI-model and can be chosen for a given modulation order and code rate. In this embodiment, for a given modulation order, various values of τ can be defined for different code rates and communicated to the UE.

In the case of non-integer based vector perturbation precoding, the quantization parameter can also be considered as a hyper parameter. In one embodiment, for each modulation order, various values of quantization parameters can be defined for each code rate and communicated to UE. In another embodiment, a single value for a given modulation order can be defined and a VPQuant field in DCI messages can be used to communicate the quantization parameter to the UE.

In another embodiment, a MAC CE identified by a MAC PDU subheader to be carried in a PDSCH can be used to indicate a VP Power Norm Index or a field VPPowerIndex in a DCI format, such as DCI_1_0 or DCI_1_1. In yet another embodiment, for low resolution power normalization factor communication, reference signals such as channel state information-reference symbol (CSI-RS) and demodulation reference symbol (DMRS) can be used.

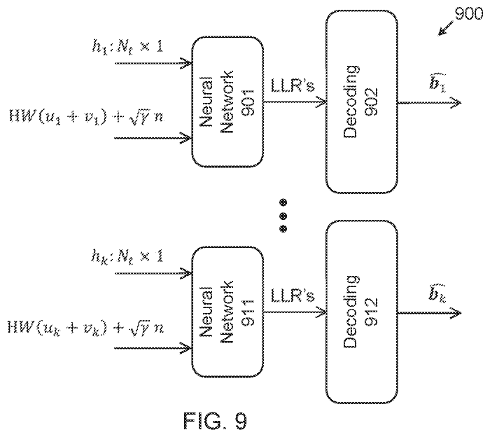

FIG. 9 illustrates one possible framework for decoding received signals with neural network support for determining vector perturbation of the transmitted signal in accordance with embodiments of the present disclosure. The framework 900 illustrated in FIG. 9 is for illustration only, and FIG. 9 does not limit the scope of this disclosure to any particular implementation. The framework 900 may be employed within UE 116 in FIGS. 1 and 3.

In the framework 900, each UE 1 through k processes a corresponding signal h₁ through hₖ received from the channel. The estimate of the effect of the channel H on the perturbed and scaled signal W (u₁+v₁) through W(uₖ+vₖ) for the respective UE (i.e., HW(u₁+v₁) through HW(uₖ+vₖ)), plus a noise factor \sqrt{γ}n, is employed by a neural network 901, 912 for the UE. Each neural network 901, 912 performs joint decoding of the perturbation vector and estimation of log-likelihood ratio (LLR) at that UE to produce, based on the respective one of signals h₁ through hₖ, an inference regarding the estimate [symbol] through [symbol] of the bit vector for the UE.

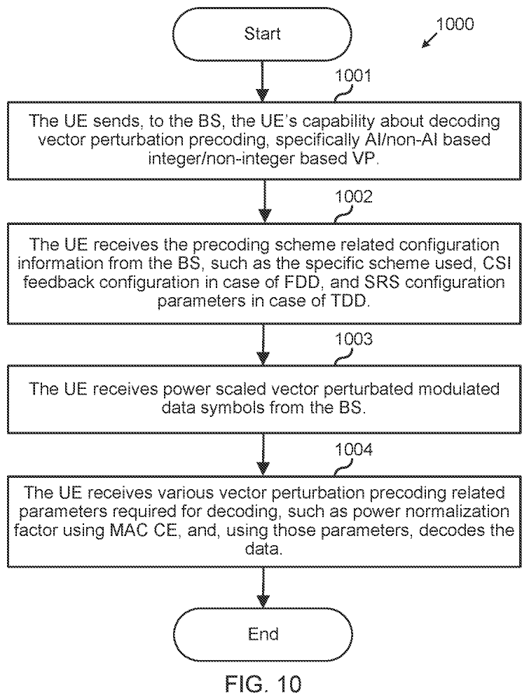

FIG. 10 is a high level flowchart of a process of UE operation to support vector perturbation precoding in accordance with embodiments of the present disclosure. The process 1000 illustrated in FIG. 10 is for illustration only, and FIG. 10 does not limit the scope of this disclosure to any particular implementation. The process 1000 may be performed by the processor 340 of FIG. 3.

FIG. 10 is an example of a method 1000 for operations at UE side to support vector perturbation precoding. At operation 1001, the UE sends the BS the UE's capability to decode vector perturbation precoding. The UE capability information related to vector perturbation precoding techniques can include one or multiple information such as
Capability to implement modulo operation for decoding integer-based scheme;
Capability to decode AI-based models for decoding non-integer based schemes.
   The report of the capability information can be sent via a PUCCH as a UCI. In another embodiment, a MAC CE identified by a MAC PDU subheader to be carried in a PUSCH can be used to indicate UE data decoding capability.

At operation 1002, the UE receives information about enabling/disabling of vector perturbation from BS based on the channel conditions. In one implementation scenario of FDD systems, the channel conditions are sent by the UE using CQI/PMI/RI; in another implementation scenario of TDD systems, the UE sends an SRS to the BS to estimate the channel.

When vector perturbation precoding is enabled, the UE may receive the related configuration information from the BS, which can include the specific vector perturbation scheme used such as integer/non-integer vector perturbation, CSI feedback reporting parameters to have highly accurate channel state information at the BS, SRS configuration information. A part or all of the configuration information can be received via UE-specific signaling, or group-specific signaling.

In one embodiment, dynamic switching between different schemes such as linear precoding, integer and non-integer vector perturbation schemes can be enabled by a combination of higher layer signaling such as a single bit VPPrecoding field in the PDSCH-config RRC message as in TABLE 1, which can be used to enable/disable vector perturbation precoding, and a field VPScheme in DCI message in a PDCCH, which can be used to indicate the enabling/disabling of vector perturbation precoding and integer-based/non-integer based vector perturbation precoding scheme for the scheduled PDSCH. The BS and UE operations are illustrated in FIGS. 7 and 8.

In another embodiment, the VPPrecoding field in the PDSCH-config RRC message can be used to communicate the specific precoding algorithm for the RRC connection session such as linear precoding, integer, non-integer vector perturbation precoding as illustrated in TABLE 3.

The BS can use the higher layer CSI reporting configuration sent to the UE using RRC messages to enable high-resolution CSI feedback, such as Type-2 CSI feedback in case of codebook based CSI feedback in FDD systems, since vector perturbation precoding algorithms require highly accurate channel state information. In one embodiment, if the UE is capable of AI-based CSI feedback, the BS can enable such AI-based feedback to have highly accurate channel state information with low overhead. In TDD systems, the BS can also configure the SRS reporting periodicity and/or transmit scale to enable high-resolution channel at the BS.

At operation 1003, the UE receives the perturbed modulated data from BS according to the configured vector perturbation scheme. In integer-based vector perturbation scheme, the optimal perturbed vector can be determined by the BS either by non-AI algorithms such as sphere decoding or AI methods. In both cases, the modulo threshold parameter can introduce the constraint in the search space. The final step of implementing vector perturbation is to perform power scaling.

At operation 1004, the UE receives vector perturbation scheme related parameters required to decode the received signal, such as the modulo threshold/quantization parameters defined specific to a modulation order and code rate. The UE may use the received parameters to decode data.

Although FIG. 10 illustrates one example process 1000 for UE operation to support vector perturbation precoding, various changes may be made to FIG. 10. For example, while shown as a series of steps, various steps in FIG. 10 may overlap, occur in parallel, or occur any number of times.

In one embodiment, the modulation order can be tied with the modulo threshold parameter τ as follows:

$$τ = 2 ( {\vert c \vert}_{max} + \frac{Δ}{2} ) , ere {\vert c \vert}_{max}$$

the absolute value of the constellation symbol(s) with largest magnitude, and Δ is the spacing between constellation points.

The value of τ can be increased, thereby increasing the decoding region at the upper and lower extremes of the constellation and potentially reducing the effects of the perturbation vector. While this improves error performance in these decoding regions, the resulting γ is typically also larger, reducing total error performance. If τ is made smaller than 2|c|ₘₐₓhen error-free decoding becomes impossible, even in the absence of channel noise.

Thus, in another embodiment, the value of τ can be considered as a hyper parameter in the AI-model and can be chosen for a given modulation order and code rate. In this embodiment, for a given modulation order, various values of τ can be defined for different code rates and communicated to the UE.

In the case of non-integer based vector perturbation precoding, the quantization parameter can also be considered as a hyper parameter. In one embodiment, for each modulation order, various values of quantization parameters can be defined for each code rate and communicated to UE. In another embodiment, a single value for a given modulation order can be defined and a VPQuant field in DCI messages can be used to communicate the quantization parameter to the UE.

In another embodiment, a MAC CE identified by a MAC PDU subheader to be carried in a PDSCH can be used to indicate a VP Power Norm Index or a field VPPowerIndex in a DCI format, such as DCI_1_0 or DCI_1_1. In yet another embodiment, for low resolution power normalization factor communication, reference signals such as CSI-RS and DMRS can be used.

With the parameters received by UE from BS, the UE can successfully decode data using the decoder corresponding to the configured precoder scheme.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a base station (BS) in a communication system, the method comprising:
enabling or disabling vector perturbation precoding of data;
transmitting, to a user equipment (UE), information including vector perturbation schemes and parameters related to vector perturbation precoding;
determining, based on the vector perturbation schemes, perturbation vectors;
modulating data signals with the perturbation vectors; and
transmitting, to the UE, the modulated data signals.

2. The method of claim 1, further comprising:
transmitting, to the UE, a downlink control information (DCI) indicating a switch between the vector perturbation schemes and a linear precoding scheme,
wherein the switching between the vector perturbation schemes and a linear precoding scheme is performed based on the DCI.

3. The method of claim 1, wherein:
the parameters related to vector perturbation precoding include a power normalization factor, a modulo threshold, and quantization parameters.

4. The method of claim 1, further comprising:
receiving, from the UE, UE data decoding capability information relating to capability of the UE to decode the modulated data signals modulated with the perturbation vectors.

5. The method of claim 1, wherein the vector perturbation schemes and parameters include an indication of UE-group specific vector perturbation precoding for a first group of UEs including the UE and linear precoding for a second group of UEs.

6. The method of claim 1, wherein the vector perturbation schemes and parameters include one of a modulo threshold parameter τ selected based on modulation order and code rate for the UE, for integer-based vector perturbation, or one of quantization parameters selected based on modulation order and code rates for the UE, for non-integer based vector perturbation.

7. The method of claim 1, wherein the vector perturbation schemes and parameters include a power normalization parameter γ communicated in one of a physical downlink shared channel (PDSCH) or a downlink control information (DCI).

8. A base station (BS) in a communication system, the BS comprising:
a transceiver; and
a processor configured to
enable or disable vector perturbation precoding of data,
transmit, to a user equipment (UE), information including vector perturbation schemes and parameters related to vector perturbation precoding,
determine, based on the vector perturbation schemes, perturbation vectors,
modulate data signals with the perturbation vectors, and
transmit, to the UE, the modulated data signals.

9. The BS of claim 8, wherein:
the processor is further configured to transmit, to the UE, a downlink control information (DCI) indicating a switch between the vector perturbation schemes and a linear precoding scheme, and
switching between the vector perturbation schemes and a linear precoding scheme is performed based on the DCI.

10. The BS of claim 8, wherein:
the parameters related to vector perturbation precoding include a power normalization factor, a modulo threshold, and quantization parameters.

11. The BS of claim 8, wherein the processor is further configured to receive, from the UE, UE data decoding capability information relating to capability of the UE to decode the modulated data signals modulated with the perturbation vectors.

12. The BS of claim 8, wherein the vector perturbation schemes and parameters include an indication of UE-group specific vector perturbation precoding for a first group of UEs including the UE and linear precoding for a second group of UEs.

13. The BS of claim 8, wherein the vector perturbation schemes and parameters include one of a modulo threshold parameter τ selected based on modulation order and code rate for the UE, for integer-based vector perturbation, or one of quantization parameters selected based on modulation order and code rates for the UE, for non-integer based vector perturbation.

14. The BS of claim 8, wherein the vector perturbation schemes and parameters include a power normalization parameter γ communicated in one of a physical downlink shared channel (PDSCH) or a downlink control information (DCI).

15. A user equipment (UE) in a communication system, the UE comprising:
a transceiver configured to
receive, from a base station (BS), signaling enabling or disabling vector perturbation precoding of data,
receive, from the BS, information including vector perturbation schemes and parameters related to vector perturbation precoding, and
receive, from the BS, data signals modulated by perturbation vectors determined based on the vector perturbation schemes; and
a processor configured to demodulate the data signals according to the perturbation vectors.

16. The UE of claim 15, wherein:
the processor is further configured to receive, from the BS, a downlink control information (DCI) indicating a switch between the vector perturbation schemes and a linear precoding scheme, and
the switching between the vector perturbation schemes and a linear precoding scheme is performed based on the DCI.

17. The UE of claim 15, wherein:
the parameters related to vector perturbation precoding include a power normalization factor, a modulo threshold, and quantization parameters.

18. The UE of claim 15, wherein the processor is further configured to transmit, to the BS, UE data decoding capability information relating to capability of the UE to decode the modulated data signals modulated with the perturbation vectors.

19. The UE of claim 15, wherein the vector perturbation schemes and parameters include an indication of UE-group specific vector perturbation precoding for a first group of UEs including the UE and linear precoding for a second group of UEs.

20. The UE of claim 15, wherein the vector perturbation schemes and parameters include one of a modulo threshold parameter τ selected based on modulation order and code rate for the UE, for integer-based vector perturbation, or one of quantization parameters selected based on modulation order and code rates for the UE, for non-integer based vector perturbation.
